(19) United States
(12) Patent Application Publication
(10) Pub. No.: US 2025/0108721 A1
(43) Pub. Date: Apr. 3, 2025

(54) POWER SUPPLY CONTROL APPARATUS, POWER SUPPLY CONTROL METHOD, AND NON-TRANSITORY STORAGE MEDIUM

(71) Applicant: NEC Corporation, Tokyo (JP)

(72) Inventors: Jun MORIZONO, Tokyo (JP); Jiroh KUBOTA, Tokyo (JP); Takuro MATSUO, Tokyo (JP)

(73) Assignee: NEC Corporation, Tokyo (JP)

(21) Appl. No.: 18/667,287

(22) Filed: May 17, 2024

(30) Foreign Application Priority Data
Sep. 28, 2023 (JP) 2023-166723

(51) Int. Cl. B60L 53/65; B60L 53/30; B60L 53/36; B60L 53/37; B60L 53/66

(52) U.S. Cl. CPC B60L 53/65; B60L 53/305; B60L 53/36; B60L 53/37; B60L 53/66; B60Y 2200/10

(57) ABSTRACT

To improve convenience of an operation for power supply control in a charging service, a power supply control apparatus according to the present disclosure includes: an acquisition unit that acquires, by using an information acquisition apparatus, user determination information that determines a user; an inquiry destination determination unit that determines information about an inquiry destination terminal of the user, based on the user determination information; a transmission/reception unit that transmits inquiry information about use of a power supply apparatus to the inquiry destination terminal; and a control unit that controls a power supply from the power supply apparatus in response to a response to the inquiry information.

This application is based upon and claims the benefit of priority from Japanese patent application No. 2023-166723, filed on Sep. 28, 2023, the disclosure of which is incorporated herein in its entirety by reference.

### TECHNICAL FIELD

The present disclosure relates to a power supply control apparatus, a power supply system, a power supply control method, and a program.

### BACKGROUND ART

A technique related to the present disclosure is disclosed in PTL 1 (Japanese Patent Application Publication (Translation of PCT Application) No. 2021-532519). PTL 1 discloses a technique related to a charging service of an electric car. The technique recognizes a vehicle number of a vehicle when the vehicle approaches an entrance of a parking lot. Then, the technique guides the vehicle to a usable charger via a user terminal associated with the recognized vehicle. Further, the technique can accept a reservation for charging via the user terminal.

### SUMMARY

A power supply apparatus that provides a charging service is also becoming widespread with widespread use of an electric car. A user controls a power supply (starts a power supply, and the like) to a vehicle by operating a power supply apparatus, but there are many users who are unfamiliar with the power supply apparatus since the power supply apparatus is still at a widespread stage, and struggle with the operation. PTL 1 discloses a technique for improving convenience of a reservation and a guide in a charging service, but does not disclose a technique for improving convenience of an operation for power supply control.

One example of an object of the present disclosure is, in view of the problem described above, to provide a power supply control apparatus, a power supply system, a power supply control method, and a program that improve convenience of an operation for power supply control in a charging service.

The present disclosure provides a power supply control apparatus including:
an acquisition unit that acquires, by using an information acquisition apparatus, user determination information that determines a user;
an inquiry destination determination unit that determines information about an inquiry destination terminal of the user, based on the user determination information;
a transmission/reception unit that transmits inquiry information about use of a power supply apparatus to the inquiry destination terminal; and
a control unit that controls a power supply from the power supply apparatus in response to a response to the inquiry information.

Further, the present disclosure provides a power supply system including: the power supply control apparatus; and a power supply apparatus in which a power supply is controlled by the power supply control apparatus.

Further, the present disclosure provides a power supply control method including,
by one or more computers:
acquiring, by using an information acquisition apparatus, user determination information that determines a user;
determining information about an inquiry destination terminal of the user, based on the user determination information;
transmitting inquiry information about use of a power supply apparatus to the inquiry destination terminal; and
controlling a power supply from the power supply apparatus in response to a response to the inquiry information.

Further, the present disclosure provides a program causing a computer to function as:
an acquisition unit that acquires, by using an information acquisition apparatus, user determination information that determines a user;
an inquiry destination determination unit that determines information about an inquiry destination terminal of the user, based on the user determination information;
a transmission/reception unit that transmits inquiry information about use of a power supply apparatus to the inquiry destination terminal; and
a control unit that controls a power supply from the power supply apparatus in response to a response to the inquiry information.

One aspect of the present disclosure achieves a power supply control apparatus, a power supply system, a power supply control method, and a program that improve convenience of an operation for power supply control in a charging service.

### BRIEF DESCRIPTION OF THE DRAWINGS

FIG. 1 is a diagram illustrating one example of a functional block diagram of a power supply control apparatus according to the present disclosure.

FIG. 2 is a flowchart illustrating one example of a flow of processing of the power supply control apparatus according to the present disclosure.

FIG. 3 is a diagram illustrating one example of a functional block diagram of a power supply system according to the present disclosure.

FIG. 4 is a diagram illustrating an example of the power supply system according to the present disclosure.

FIG. 5 is a diagram illustrating one example of a hardware configuration of the apparatus according to the present disclosure.

FIG. 6 is a diagram illustrating another example of a functional block diagram of the power supply control apparatus according to the present disclosure.

FIG. 7 is a diagram illustrating one example of information processed by the power supply control apparatus according to the present disclosure.

FIG. 8 is a flowchart illustrating another example of a flow of processing of the power supply control apparatus according to the present disclosure.

FIG. 9 is a sequence diagram illustrating one example of a flow of processing of the power supply system according to the present disclosure.

FIG. 10 is a diagram illustrating another example of information processed by the power supply control apparatus according to the present disclosure.

FIG. 11 is a diagram illustrating another example of information processed by the power supply control apparatus according to the present disclosure.

FIG. 12 is a sequence diagram illustrating another example of a flow of processing of the power supply system according to the present disclosure.

FIG. 13 is a sequence diagram illustrating another example of a flow of processing of the power supply system according to the present disclosure.

FIG. 14 is a sequence diagram illustrating another example of a flow of processing of the power supply system according to the present disclosure.

FIG. 15 is a sequence diagram illustrating another example of a flow of processing of the power supply system according to the present disclosure.

### EXAMPLE EMBODIMENT

Hereinafter, example embodiments of the present disclosure will be described by using drawings. In the present disclosure, the drawing is associated with one or more example embodiments. Further, in all of the drawings, a similar component is denoted by a similar reference sign, and description thereof will be appropriately omitted.

### First Example Embodiment

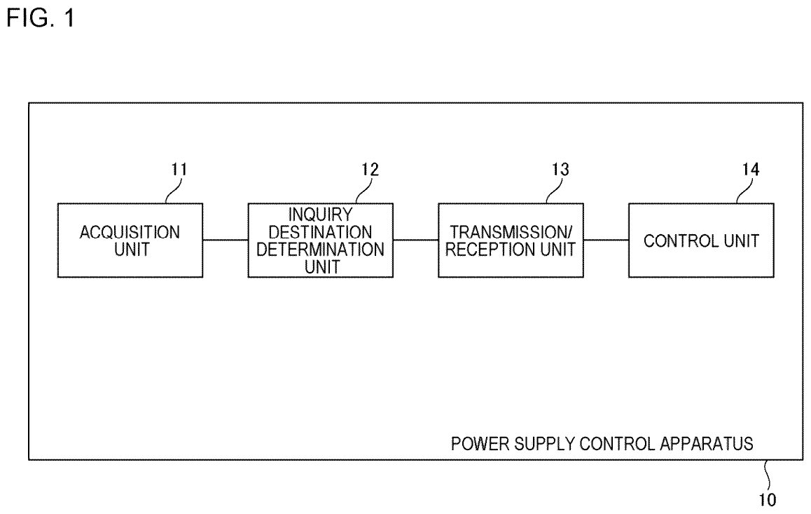

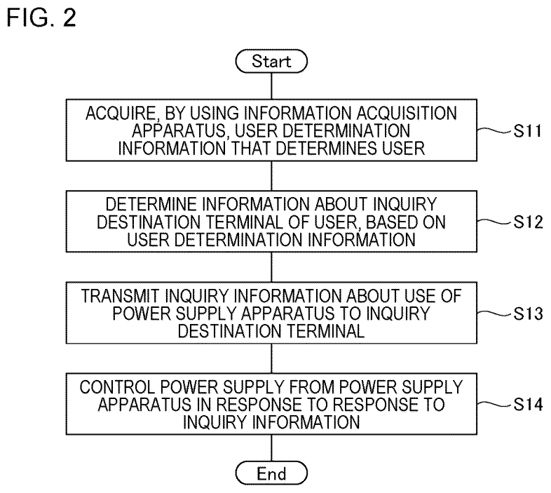

FIG. 1 is a functional block diagram illustrating an overview of a power supply control apparatus 10. FIG. 2 is a flowchart illustrating one example of a flow of processing performed by the power supply control apparatus 10.

As illustrated in FIG. 1, the power supply control apparatus 10 includes an acquisition unit 11, an inquiry destination determination unit 12, a transmission/reception unit 13, and a control unit 14. The acquisition unit 11, the inquiry destination determination unit 12, the transmission/reception unit 13, and the control unit 14 perform the processing of the flowchart in FIG. 2.

The acquisition unit 11 acquires, by using an information acquisition apparatus, user determination information that determines a user (S11).

The inquiry destination determination unit 12 determines information about an inquiry destination terminal of the user, based on the user determination information acquired in S11 (S12).

The transmission/reception unit 13 transmits, by using the information about the inquiry destination terminal of the user being determined in S12, inquiry information about use of a power supply apparatus to the inquiry destination terminal of the user (S13).

The control unit 14 controls a power supply from the power supply apparatus in response to a response to the inquiry information transmitted in S13 (S14).

In this way, the power supply control apparatus 10 transmits inquiry information about use of a power supply apparatus to an inquiry destination terminal of a user, and controls a power supply from the power supply apparatus in response to a response to the inquiry information. Such a power supply control apparatus 10 can improve convenience of an operation for power supply control in a charging service.

For example, when a power supply from a power supply apparatus is controlled by operating the power supply apparatus, a user brings an electric moving body and the power supply apparatus into a state where the power supply can be achieved, and then the user needs to take the trouble to go to a place of the power supply apparatus in order to perform an operation of controlling the power supply. Bringing an electric moving body and a power supply apparatus into a state where a power supply can be achieved means that the electric moving body and the power supply apparatus are connected with a cable and the like, the electric moving body is placed in a position where a wireless power supply can be achieved from the power supply apparatus, and the like. In contrast, in a case of the power supply control apparatus 10 that can control a power supply from a power supply apparatus in response to an operation of an inquiry destination terminal of a user, the user can bring an electric moving body and the power supply apparatus into a state where the power supply can be achieved, and the user can then control the power supply from the power supply apparatus by operating his/her inquiry destination terminal on the spot. For example, when a power supply apparatus can achieve a wireless power supply, a user can control the power supply from the power supply apparatus without getting off an electric moving body after the user parks the electric moving body in a position where the power supply can be achieved from the power supply apparatus.

Further, the power supply control apparatus 10 actively acquires user determination information, determines information about an inquiry destination terminal of a user, based on the acquired user determination information, and transmits various pieces of information to the inquiry destination terminal of the user by using the determined information about the inquiry destination terminal of the user. Thus, the user does not need to perform an operation for receiving various pieces of information, for example, an operation for reading a code (such as a one-dimensional code and a two-dimensional code) installed on the spot with a portable terminal, and the like. In this way, the power supply control apparatus 10 can save time and effort of work of a user.

Further, a user can control a power supply from a power supply apparatus by operating his/her inquiry destination terminal the user is accustomed to using instead of operating the unfamiliar power supply apparatus. Such a power supply control apparatus 10 can improve convenience of an operation for power supply control in a charging service.

Further, a power supply apparatus installed at a public place can be operated by anybody, but an inquiry destination terminal of each user can be operated by only each user. Such a power supply control apparatus 10 that controls a power supply from a power supply apparatus in response to a response from an inquiry destination terminal of a user can suppress spoofing behavior in which a user other than a true user pretends to be another user and unreasonably uses a charging service.

### Second Example Embodiment

### Overview

A power supply control apparatus 10 according to a second example embodiment is acquired by embodying the configuration of the power supply control apparatus 10 according to the first example embodiment. Details will be described below.

### <Overall Perspective of Power Supply System>

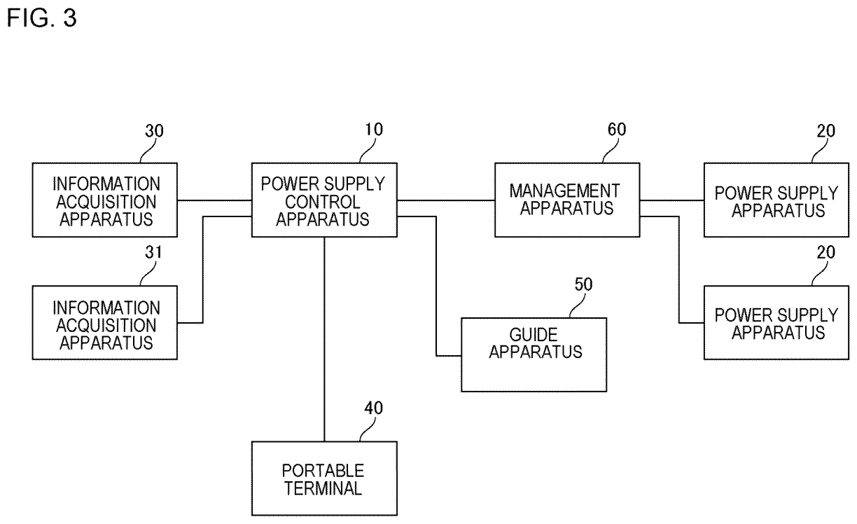

First, an overall perspective of a power supply system including the power supply control apparatus 10 will be described by using FIG. 3. As illustrated in FIG. 3, in one example, the power supply system includes the power supply control apparatus 10, a power supply apparatus 20, an information acquisition apparatus 30, an information acquisition apparatus 31, a portable terminal 40, a guide apparatus 50, and a management apparatus 60. The components can communicate with one another via a wired and/or wireless communication network.

Note that, the power supply system may not include some of the components indicated herein. Some of the components not included in the power supply system may be present as components outside the power supply system. Then, the power supply system and the components outside the power supply system may perform predetermined processing in cooperation. In addition, some of the components not included in the power supply system may not get involved in processing performed by the power supply system. Further, some of the components not included in the power supply system may not be present as components outside the power supply system.

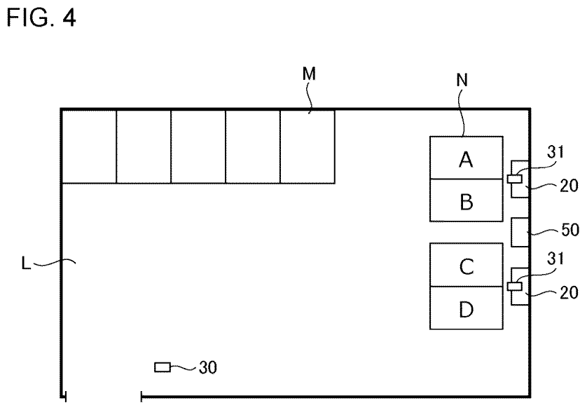

Next, each of the components will be described with reference to FIGS. 3 and 4. FIG. 4 illustrates an example of the power supply system. Note that, the example in FIG. 4 is merely one example, which is not limited thereto.

In the example in FIG. 4, various components are installed in a predetermined area L. A charging service of an electric moving body is provided in the area L. The area L may be an area provided exclusively for a charging service, may be a parking lot of any facility, may be an area of a facility that provides a service related to a moving body such as a gas station, or may be the other area.

The “electric moving body” is a moving body that moves with electricity as a power source. As the “moving body”, for example, a car, a bicycle, a full-sized car, an electric scooter, and the like are exemplified, which are not limited thereto. As the full-sized car, a truck, a bus, and the like are exemplified, which are not limited thereto.

The “power supply apparatus 20” is an apparatus that supplies power to an electric moving body. A configuration of the power supply apparatus 20 is not particularly limited. The power supply apparatus 20 can adopt every widely known configuration. The power supply apparatus 20 may be a quick charger or a normal charger. Further, the power supply apparatus 20 may be a type that supplies power in a wired connection state. Further, the power supply apparatus 20 may have a configuration that can achieve a wireless power supply.

Further, one power supply apparatus 20 may have a configuration provided with one power supply unit (such as a cable, a plug, and an antenna). In addition, one power supply apparatus 20 may have a configuration provided with a plurality of (for example: two) power supply units. One power supply apparatus 20 in the example in FIG. 4 has a configuration provided with two power supply units. Thus, two charging parking spaces N are provided in association with one power supply apparatus 20. A user who uses a charging service parks his/her electric moving body in the charging parking space N, and brings the electric moving body and the power supply apparatus 20 into a state where a power supply can be achieved. In the example in FIG. 4, two power supply apparatuses 20 are installed in the area L. However, the number of the power supply apparatuses 20 installed in the area L is not limited to this.

Note that, a greater number of the power supply units and the charging parking spaces N than the number in which a power supply can be achieved at once from one power supply apparatus 20 may be provided in association with one power supply apparatus 20. In one example, the power supply apparatus is configured to be able to simultaneously supply power to two electric moving bodies by assigning an output to the two electric moving bodies. Three or more power supply units and charging parking spaces N may be provided in association with such a power supply apparatus 20. In this way, when the power supply apparatus 20 simultaneously supplies power to two electric moving bodies, a user can park in a third or subsequent parking space associated with the power supply apparatus 20 and bring an electric moving body and the power supply apparatus 20 into a state where a power supply can be achieved. Then, the user can wait until the power supply to one of the two electric moving bodies being supplied with power is completed and a user's turn comes. Note that, according to the power supply control apparatus 10, a user can remotely control a power supply from the power supply apparatus 20 by operating his/her portable terminal 40. Thus, a user who has parked in a third or subsequent parking space and brought an electric moving body and the power supply apparatus 20 into a state where a power supply can be achieved can leave the spot.

The “information acquisition apparatus 30” has a camera function. As illustrated in FIG. 4, the information acquisition apparatus 30 is installed in a vicinity of an entrance of the area L, and captures the vicinity of the entrance of the area L. The information acquisition apparatus 30 is installed in a position and an orientation in which an electric moving body present in the vicinity of the entrance of the area L is captured. For example, the information acquisition apparatus 30 is installed in a position and an orientation in which a license plate of an electric moving body present in the vicinity of the entrance of the area L is captured.

The information acquisition apparatus 30 may continuously capture a moving image. In addition, the information acquisition apparatus 30 may capture a still image or a moving image having a predetermined length at a predetermined timing. For example, the information acquisition apparatus 30 may capture a still image or a moving image having a predetermined length at a timing at which an object is detected in the vicinity of the entrance of the area L by any object detection sensor. Further, the information acquisition apparatus may capture a moving image while an object is detected in the vicinity of the entrance of the area L by any object detection sensor.

The “information acquisition apparatus 31” has a camera function. As illustrated in FIG. 4, the information acquisition apparatus 31 is installed in a vicinity of each power supply apparatus 20 in association with each power supply apparatus 20. For example, the information acquisition apparatus 31 is installed in a position and an orientation in which an electric moving body parked in the charging parking space N is captured. In one example, the information acquisition apparatus 31 is installed in a position and an orientation in which a license plate of an electric moving body parked in the charging parking space N is captured. In addition, the information acquisition apparatus 31 may be installed in a position and an orientation in which a user (for example, a face of a user) who gets off an electric moving body, performs work for connecting the electric moving body parked in the charging parking space N and the power supply apparatus 20, and the like is captured.

The information acquisition apparatus 31 may continuously capture a moving image. In addition, the information acquisition apparatus 31 may capture a still image or a moving image having a predetermined length at a predetermined timing. For example, the information acquisition apparatus 31 may capture a still image or a moving image having a predetermined length at a timing at which an object in the charging parking space N is detected by any object detection sensor. Further, the information acquisition apparatus 31 may capture a moving image while an object is detected in the charging parking space N by any object detection sensor.

The “guide apparatus 50” outputs guide information that guides an electric moving body to the charging parking space N. The guide apparatus 50 includes an output apparatus such as a display, a projection apparatus, a speaker, and a lamp. The guide apparatus 50 outputs the guide information via the output apparatus.

For example, the guide information may be a content such as “A and B charging parking spaces are usable. Move toward one you like.” and “Move toward vacant charging parking space.”. In addition, a lamp may be provided in association with each of the plurality of charging parking spaces N. Then, the guide apparatus 50 may turn on a lamp associated with a vacant charging parking space N.

In addition, the guide information may be a content that guides a predetermined user to a predetermined charging parking space N. For example, the guide information may be a content such as “Customer of user identification information ∘∘, please move toward A charging parking space.” and “Customer of user identification information ^{x x}, please move toward B charging parking space.”. A unit that achieves an output of such guide information will be described below in detail.

As illustrated in FIG. 4, a parking space M for waiting for a turn may be provided in the area L. When all of the power supply apparatuses 20 are being used, a user can park in the parking space M and wait until the power supply apparatus 20 is available. The parking space M may be a parking space exclusive for waiting for a turn for a charging service. In addition, the parking space M may be a parking space shared with a customer of a facility adjacent to the area L, and the like.

The “management apparatus 60” (not illustrated in FIG. 4) manages the power supply apparatus 20 installed in the area L. The management apparatus 60 may be an apparatus installed in the area L, in a vicinity of the area L, or at the other place, or may be a cloud server.

For example, the management apparatus 60 can control motion of each power supply apparatus 20, based on information acquired from the power supply control apparatus 10. Further, for example, the management apparatus 60 can acquire information about a power supply from each power supply apparatus 20, and transmit the information to the power supply control apparatus 10. The information about a power supply can include a power supply amount (kWh), a power supply time, a content of a user input when the power supply apparatus 20 accepts the user input, and the like. Note that, the information about a power supply may include the other information.

The “portable terminal 40” (not illustrated in FIG. 4) is an apparatus carried by each user. The portable terminal 40 is, for example, a smartphone, a tablet terminal, a smartwatch, a notebook computer, a cellular phone, and the like, which are not limited thereto. For example, each user can confirm the guide information described above via his/her portable terminal 40. In other words, the guide information described above may be output via the portable terminal 40 of each user instead of or in addition to the guide apparatus 50. Further, each user can control a power supply from the power supply apparatus via his/her portable terminal 40. Details of the processing by the portable terminal 40 will be described below.

The “power supply control apparatus 10” (not illustrated in FIG. 4) may be an apparatus installed in the area L, in a vicinity of the area L, or at the other place, or may be a cloud server. The power supply control apparatus 10 performs the processing described in the first example embodiment in cooperation with various kinds of the apparatuses described above. As a result, a user can control a power supply from the power supply apparatus 20 by operating his/her portable terminal 40 (inquiry destination terminal) the user is accustomed to using instead of operating the unfamiliar power supply apparatus 20. The functional configuration of the power supply control apparatus 10 will be described below in detail.

### <Hardware Configuration of Each Component>

Next, one example of a hardware configuration of each component included in the power supply system will be described. A functional unit of each component is achieved by any combination of hardware and software. Various modification examples of a method and an apparatus for achieving that are understood by a person skilled in the art. The software includes a program stored at a shipment stage of an apparatus in advance, a program downloaded from a storage medium such as a compact disc (CD), a server on the Internet, and the like, and the like.

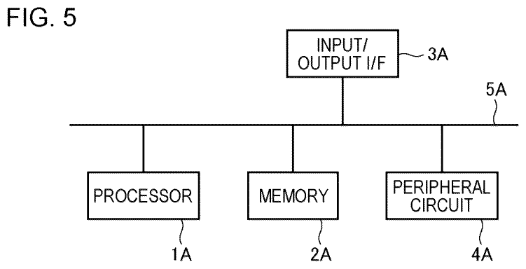

FIG. 5 is a block diagram illustrating a hardware configuration of each component included in the power supply system. As illustrated in FIG. 5, each component included in the power supply system includes a processor 1A, a memory 2A, an input/output interface 3A, a peripheral circuit 4A, and a bus 5A. Various modules are included in the peripheral circuit 4A. Each component included in the power supply system may not include the peripheral circuit 4A. Note that, each component included in the power supply system may be formed of a plurality of apparatuses being separated physically and/or logically. In this case, each of the plurality of apparatuses can include the hardware configuration described above.

The bus 5A is a data transmission path for the processor 1A, the memory 2A, the peripheral circuit 4A, and the input/output interface 3A to transmit and receive data to and from one another. The processor 1A is an arithmetic processing apparatus such as a CPU and a graphics processing unit (GPU), for example. The memory 2A is a memory such as a random access memory (RAM) and a read only memory (ROM), for example. The input/output interface 3A includes an interface for acquiring information from an input apparatus, an external apparatus, an external server, an external sensor, a camera, and the like, an interface for outputting information to an output apparatus, an external apparatus, an external server, and the like, and the like. Further, the input/output interface 3A includes an interface for connection to a communication network such as the Internet. The input apparatus is, for example, a keyboard, a mouse, a microphone, a physical button, a touch panel, and the like. The output apparatus is, for example, a display, a speaker, a printer, a mailer, and the like. The processor 1A can output an instruction to each of modules, and perform an arithmetic operation, based on an arithmetic result of the modules.

### <Functional Configuration of Power Supply Control Apparatus 10>

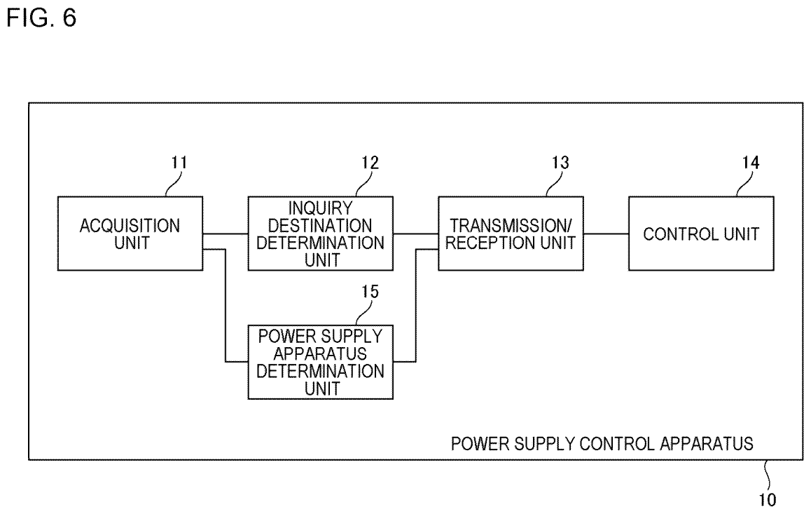

Next, the functional configuration of the power supply control apparatus will be described in detail. FIG. 6 illustrates one example of a functional block diagram of the power supply control apparatus 10. As illustrated, the power supply control apparatus 10 includes an acquisition unit 11, an inquiry destination determination unit 12, a transmission/reception unit 13, a control unit 14, and a power supply apparatus determination unit 15.

The acquisition unit 11 acquires, by using at least one of the information acquisition apparatus 30 and the information acquisition apparatus 31, user determination information that determines a user.

When both of the information acquisition apparatus 30 and the information acquisition apparatus 31 are installed in the area L, the acquisition unit 11 can acquire user determination information by using both. When only one of the information acquisition apparatus 30 and the information acquisition apparatus 31 is installed in the area L, the acquisition unit 11 can acquire user determination information by using the one installed in the area L.

The “user determination information” is information that identifies a plurality of users from each other and determines a predetermined user. The user determination information includes at least one of user identification information unique to each user and identification information (hereinafter, “moving body identification information”) about a moving body used by each user.

The “moving body identification information” is registration information being registered in a predetermined institution for each moving body, and is information about a so-called license plate. The moving body identification information can include information indicating a registration region, information indicating a use, information indicating a kind, an identification number, and the like.

The “user identification information” is information that identifies, from each other, users who use a charging service using the power supply apparatus 20. A user who uses the charging service performs user registration in advance. At that time, user identification information unique to each user is provided to each user.

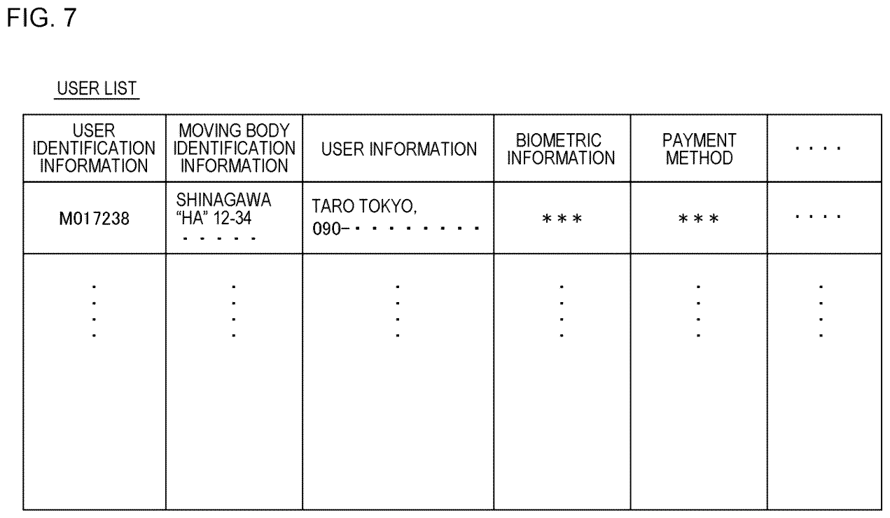

The user registration can be achieved by using every widely known technique such as an online procedure and submission of a document by mail or at a window. In the user registration, various pieces of information are registered. FIG. 7 illustrates one example of information registered in the user registration. In the example in FIG. 7, user identification information, moving body identification information, user information, biometric information, a payment method, and the like are registered in association with one another.

As described above, the “user identification information” is information that identifies, from each other, users who use a charging service using the power supply apparatus 20. At a time of the user registration, the user identification information unique to each user is provided to each user.

As described above, the “moving body identification information” is registration information being registered in a predetermined institution for each moving body, and is information about a so-called license plate. Each user registers the moving body identification information about a moving body used by the user.

The “user information” is various pieces of information about a user. The user information can include, for example, a name, an age, gender, an address, a phone number of a house, a phone number of the portable terminal 40, an e-mail address, an identifier (ID) of a social networking service (SNS), and the like.

The “biometric information” is information about a living body of each user, and is used in authentication processing. The biometric information is suitably face information, but may be the other information such as fingerprint information, iris information, and voiceprint information.

The “payment method” is information about a payment method used when a charging service is used. The payment method is, for example, credit card information, information for performing payment with electronic money and a point, account information of a bank, and the like, which are not limited thereto.

The acquisition unit 11 may acquire, from at least one of the information acquisition apparatus 30 and the information acquisition apparatus 31, an image generated by the apparatuses. Then, the acquisition unit 11 may determine moving body identification information about a moving body captured in the acquired image by analyzing the image, and recognizing a character and a number. In addition, the acquisition unit 11 may determine user identification information about a person captured in the acquired image by analyzing the image, and verifying face information about the person captured in the image with face information about a person registered in a user list (see FIG. 7).

In addition, at least one of the information acquisition apparatus 30 and the information acquisition apparatus 31 may determine moving body identification information about a moving body captured in an image and determine user identification information about a person captured in an image by performing the image analysis described above. Then, the acquisition unit 11 may acquire the determined moving body identification information and the determined user identification information from at least one of the information acquisition apparatus 30 and the information acquisition apparatus 31.

Returning to FIG. 6, the inquiry destination determination unit 12 determines information about an inquiry destination terminal of the user, based on the user determination information acquired by the acquisition unit 11.

The “inquiry destination terminal” is an apparatus carried by each user, and is the portable terminal 40 described above.

The “information about an inquiry destination terminal” is information for transmitting information to the portable terminal 40. The power supply control apparatus 10 can transmit information to the portable terminal 40 by using every widely known technique.

The information about an inquiry destination terminal is, for example, user identification information described above. In this case, each user installs an application used in a charging service into his/her portable terminal 40. The application used in the charging service may be specialized in the charging service, or may not be specialized in the charging service. Then, each user logs into the application by using his/her user identification information. In a login state, the power supply control apparatus 10 can manage a correspondence between the portable terminal 40 and the user identification information. As a result, the power supply control apparatus 10 can transmit information to the portable terminal 40 via the portable terminal 40 logging into the application.

In addition, the information about an inquiry destination terminal may be a phone number of the portable terminal 40. In this case, the power supply control apparatus 10 can transmit information to the portable terminal 40 by a means such as a short message and a call.

In addition, the information about an inquiry destination terminal may be an e-mail address of a user. In this case, the power supply control apparatus transmits information to the e-mail address. Transmission of information to the portable terminal 40 is achieved by downloading a message transmitted to the e-mail address into the portable terminal 40.

For example, the inquiry destination determination unit 12 can search for a user list (see FIG. 7) being registered in advance with the user determination information acquired by the acquisition unit 11 as a key, and determine information about an inquiry destination terminal associated with the key.

Returning to FIG. 6, the power supply apparatus determination unit 15 determines, based on the user determination information acquired by the acquisition unit 11, the power supply apparatus 20 used by the user identified by the user determination information.

For example, the acquisition unit 11 acquires user determination information by using the information acquisition apparatus 31 installed in the vicinity of each power supply apparatus 20 in association with each power supply apparatus 20 as illustrated in FIG. 4. In this case, the power supply apparatus determination unit 15 can determine the power supply apparatus 20 associated with the information acquisition apparatus 31 used for acquiring the user determination information as the power supply apparatus 20 used by the user. Each power supply apparatus 20 and the information acquisition apparatus 31 installed in the vicinity of each power supply apparatus 20 are registered in advance in association with each other in the power supply control apparatus 10.

In addition, at least one camera may be installed in such a way as to capture the entire region of the area L. In this case, the acquisition unit 11 acquires moving body identification information (user determination information) about a moving body captured in an image by using the information acquisition apparatus 30 installed in the vicinity of the entrance of the area L as illustrated in FIG. 4. Subsequently, the power supply apparatus determination unit 15 tracks the moving body in the image generated by the at least one camera that captures the entire region of the area L described above, and determines the charging parking space N in which the moving body is parked. Then, the power supply apparatus determination unit 15 determines the power supply apparatus 20 associated with the determined charging parking space N as the power supply apparatus 20 used by the user. Each power supply apparatus 20 and the charging parking space N in which a moving body is parked when each power supply apparatus 20 is used are registered in advance in association with each other in the power supply control apparatus 10.

Note that, tracking of a moving body in an image is achieved by using a widely known object tracking technique. In one example, a feature value acquired from an appearance of a moving body may be used. As the feature value, a color, a type of a car, a manufacturer, and the like are exemplified, which are not limited thereto.

Returning to FIG. 6, the transmission/reception unit 13 transmits, by using the information about the inquiry destination terminal of the user being determined by the inquiry destination determination unit 12, inquiry information about use of the power supply apparatus 20 determined by the power supply apparatus determination unit 15 to the inquiry destination terminal of the user.

The transmission/reception unit 13 can transmit the inquiry information to the inquiry destination terminal of the user at a predetermined timing after the information about the inquiry destination terminal of the user is determined and the power supply apparatus 20 used by the user is determined. The predetermined timing is, for example, a timing (such as a timing at which a connection is detected) at which the power supply apparatus 20 used by the user and the electric moving body are brought into a state where a power supply can be achieved, which is not limited thereto.

The “inquiry information about use of the power supply apparatus 20” includes a user interface (UI) screen for controlling a power supply of the power supply apparatus 20, or information (such as a URL) for accessing the UI screen.

The UI screen includes a UI part (such as a button) that accepts an instruction to start a power supply. Further, the UI screen may include a UI part (such as a radio button and a drop-down list) that specifies a power amount for a power supply or a time for a power supply.

Further, the UI screen may include information indicating the power supply apparatus 20 determined as the power supply apparatus 20 used by the user. For example, identification information (such as a serial number) about the determined power supply apparatus 20 may be displayed, or identification information about the charging parking space N associated with the determined power supply apparatus 20 may be displayed. By visually recognizing the information, the user can confirm that the power supply control apparatus 10 properly recognizes the power supply apparatus 20 used by the user.

The control unit 14 controls a power supply from the power supply apparatus 20 in response to a response to the UI screen (inquiry information) transmitted from the transmission/reception unit 13.

For example, the user performs an operation on the UI part that accepts an instruction to start a power supply in the UI screen displayed on the portable terminal 40. Then, the portable terminal 40 transmits information indicating that the operation is accepted to the power supply control apparatus 10 via the UI screen. Then, the control unit 14 starts a power supply from the power supply apparatus 20 in response to the operation on the UI part that accepts an instruction to start a power supply.

Further, the user can perform an operation of specifying a power amount for a power supply or a time for a power supply in the UI screen displayed on the portable terminal 40. Then, the portable terminal 40 transmits information indicating a content specified by the operation to the power supply control apparatus 10 via the UI screen. Then, the control unit 14 causes the power supply apparatus 20 to supply power in the power amount or the time being specified on the UI screen.

The control unit 14 transmits, to the management apparatus 60, control information including information that identifies the power supply apparatus 20 to be controlled, instruction information that starts a power supply, a power amount for a power supply, a time for a power supply, and the like. The management apparatus 60 determines, based on the control information, the power supply apparatus 20 that controls a power supply. Then, the management apparatus 60 transmits a predetermined command to the determined power supply apparatus 20, and causes the power supply apparatus 20 to start a power supply. Further, the management apparatus 60 transmits a predetermined command to the determined power supply apparatus 20, and causes the power supply apparatus 20 to supply power in a predetermined power amount or a predetermined time. The power supply apparatus 20 performs power supply processing according to the command from the management apparatus 60. Note that, a stop of a power supply, settlement processing, and the like can be achieved by using every widely known technique.

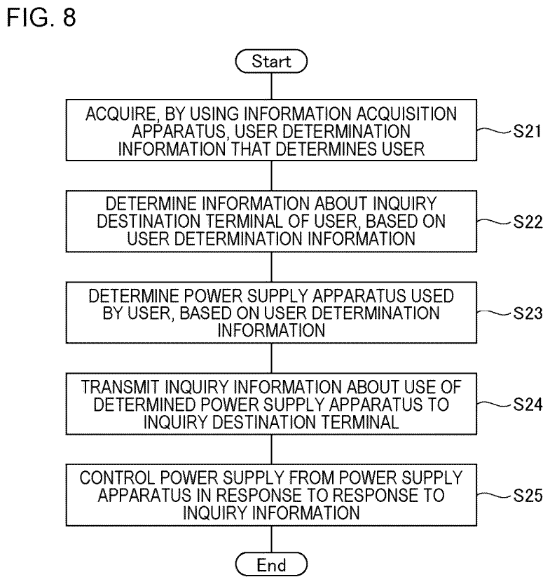

Next, one example of a flow of processing performed by the power supply control apparatus 10 will be described by using a flowchart in FIG. 8.

First, the power supply control apparatus 10 acquires, by using at least one of the information acquisition apparatus 30 and the information acquisition apparatus 31, user determination information that determines a user (S21). The user determination information includes at least one of user identification information and moving body identification information. At least one of the user identification information and the moving body identification information is determined by analyzing an image generated by at least one of the information acquisition apparatus 30 and the information acquisition apparatus 31.

Next, the power supply control apparatus 10 determines information about an inquiry destination terminal of the user, based on the user determination information acquired in S21 (S22). For example, the power supply control apparatus 10 can search for information (see FIG. 7) being registered in advance with the user determination information acquired in S21 as a key, and determine information about an inquiry destination terminal associated with the key.

Further, the power supply control apparatus 10 determines the power supply apparatus 20 used by the user, based on the user determination information acquired in S21 (S23). For example, the power supply control apparatus 10 may determine the power supply apparatus 20 used by the user by acquiring the user determination information by using the information acquisition apparatus 31 associated with each power supply apparatus 20. In addition, the power supply control apparatus 10 may determine the power supply apparatus 20 used by the user by tracking, in the area L, an electric moving body having vehicle identification information being determined. Note that, the processing order of the processing in S22 and the processing in S23 may be reversed.

Next, the power supply control apparatus 10 transmits, by using the information about the inquiry destination terminal of the user being determined in S22, inquiry information about use of the power supply apparatus 20 being determined in S23 to the portable terminal 40 (inquiry destination terminal) of the user (S24). The inquiry information can include a UI screen including a UI part that accepts an instruction to start a power supply, or information (such as a URL) for accessing the UI screen.

Then, the power supply control apparatus 10 controls a power supply from the power supply apparatus 20 in response to a response to the inquiry information transmitted in S24 (S25). For example, the user performs an operation on the UI part that accepts an instruction to start a power supply in the UI screen displayed on the portable terminal 40. Then, the portable terminal 40 transmits information indicating that the operation is accepted to the power supply control apparatus 10 via the UI screen. Then, the power supply control apparatus 10 starts a power supply from the power supply apparatus 20 determined in S23 in response to the operation on the UI part that accepts an instruction to start a power supply.

For example, the power supply control apparatus 10 transmits, to the management apparatus 60, control information including information that identifies the power supply apparatus 20 to be controlled, instruction information that starts a power supply, and the like. The management apparatus 60 determines, based on the control information, the power supply apparatus 20 that controls a power supply. Then, the management apparatus 60 transmits a predetermined command to the determined power supply apparatus 20, and causes the power supply apparatus 20 to start a power supply. The power supply apparatus 20 performs power supply processing according to the command from the management apparatus 60. Note that, subsequent processing such as a stop of a power supply and settlement processing can be achieved by using every widely known technique. For example, the power supply control apparatus 10 may provide notification that a power supply is completed via the portable terminal 40 of the user. Further, the power supply control apparatus 10 may accept settlement processing via the portable terminal of the user.

### <Example of Power Supply System>

Next, a specific example of the power supply system including the power supply control apparatus 10 as described above will be described. Note that, the example described below is merely one example, and a method for achieving the power supply system is not limited to this.

### Example 1 (Flow of Representative Processing)

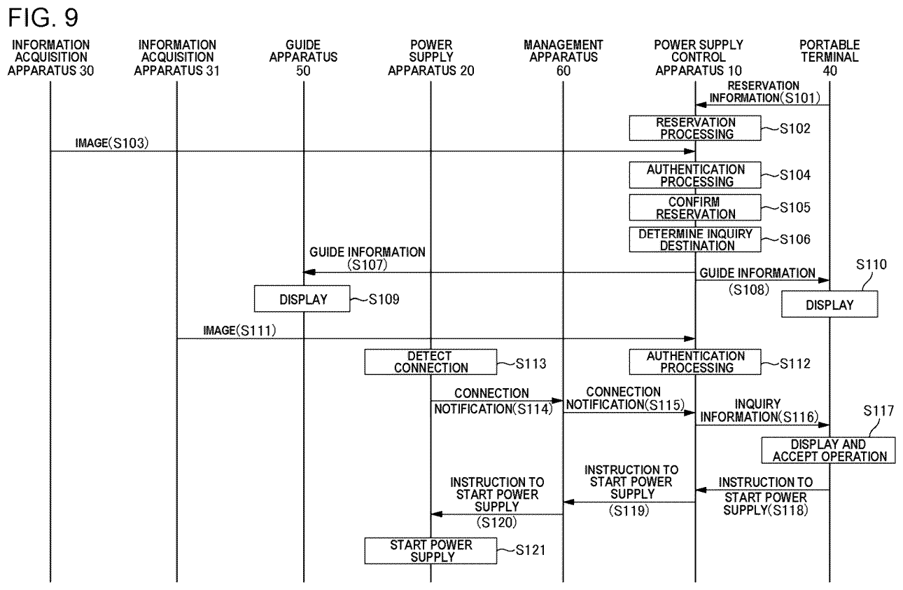

One example of a flow of representative processing of the power supply system will be described by using a sequence diagram in FIG. 9.

First, in the example, a user can perform a reservation for a charging service. For example, a user who has completed user registration can perform the reservation. The user can perform the reservation before the user arrives at the area L (area where the charging service is provided). Thus, a waiting time after the user arrives at the area L can be reduced.

The power supply system can accept the reservation by using every technique. For example, the user activates an application used in the charging service by operating the portable terminal 40. Then, the user specifies the area L to be reserved, and performs an input for performing the reservation in the specified area L. In response to the input, the portable terminal 40 transmits information indicating the specified area L and reservation information including a request for the reservation to the power supply control apparatus 10 (S101).

The power supply control apparatus 10 performs reservation processing in response to reception of the reservation information (S102). For example, the power supply control apparatus 10 updates a managed reservation list in response to reception of the reservation information. Note that, the power supply control apparatus 10 may transmit a reservation completion notification to the portable terminal 40 in response to the update of the reservation list. Then, the portable terminal 40 may notify the user of the reservation completion.

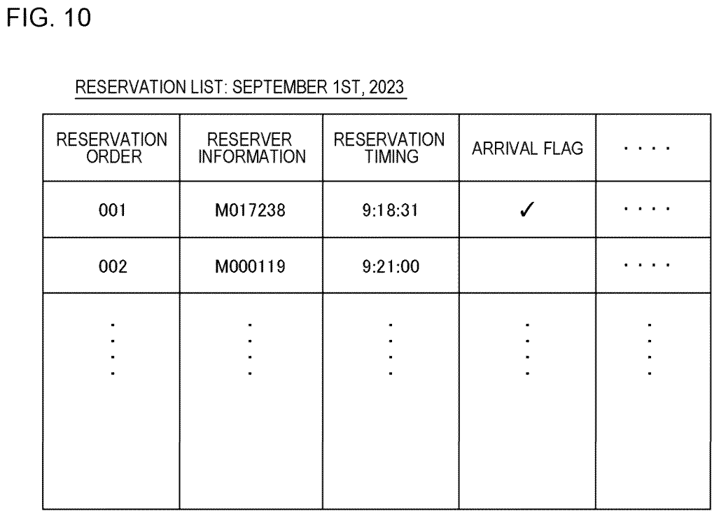

FIG. 10 illustrates one example of a reservation list. The power supply control apparatus 10 can manage the reservation list as in FIG. 10 for each area L. The illustrated reservation list includes a reservation order, reserver information, a reservation timing, and an arrival flag. Note that, the reservation list may not include some pieces of the information, or may include another piece of information.

The “reservation order” indicates an order in which a reservation is accepted.

The “reserver information” is information that determines a reserver. The reserver information may be, for example, user identification information and moving body identification information.

The “reservation timing” indicates a timing at which a reservation is accepted. In the example in the diagram, a time at which a reservation is accepted is indicated.

The “arrival flag” indicates whether a reserver has arrived at the reserved area L.

The power supply control apparatus 10 adds a user to a last reservation order when a new reservation is accepted.

There are various units that accept an input for specifying the area L reserved from a user. In one example, when a user performs an input for starting a reservation for a charging service, the power supply control apparatus may search for the nearest area L, based on position information about the portable terminal 40, and transmit a search result to the portable terminal 40. The user can specify a desired area L from among the provided areas L by operating the portable terminal 40. The power supply control apparatus 10 can achieve provision of the search result described above, based on a position information acquisition function (such as a global positioning system function) of the portable terminal 40 and position information about each of the plurality of preregistered areas L. The nearest area L is the area L whose distance from the portable terminal 40 is equal to or less than a reference value, a predetermined number of the areas L having a shorter distance from the portable terminal 40, or the like, which is not limited thereto. Note that, the unit exemplified herein is merely one example, which is not limited thereto.

The user who has completed the reservation goes on an electric moving body and moves to the reserved area L.

Returning to FIG. 9, when the user who has completed the reservation arrives at the reserved area L, the electric moving body of the user and/or the user is captured in an image generated by the information acquisition apparatus installed in the vicinity of the entrance of the area L. Then, the information acquisition apparatus 30 transmits the image (image in which the electric moving body of the user and/or the user is captured) to the power supply control apparatus 10 (S103).

The power supply control apparatus 10 performs authentication processing, based on the image (S104). For example, the power supply control apparatus 10 analyzes the image, and determines moving body identification information about a moving body captured in the image. Then, the power supply control apparatus 10 verifies the determined moving body identification information with moving body identification information (see FIG. 7) registered in advance in user registration, and authenticates whether the user is a valid user. When the user is a valid user, the power supply control apparatus 10 can determine user identification information about the user.

Alternatively, the power supply control apparatus 10 analyzes the image, and extracts biometric information about a user captured in the image. Then, the power supply control apparatus 10 verifies the extracted biometric information with biometric information (see FIG. 7) about the user registered in advance in user registration, and authenticates whether the user is a valid user. When the user is a valid user, the power supply control apparatus 10 can determine user identification information about the user.

After the authentication succeeds, the power supply control apparatus 10 refers to the reservation list (FIG. 10), and confirms whether the user has made a reservation (S105). As described above, the user has completed the reservation. Thus, the power supply control apparatus 10 determines that the user has made the reservation. In response to this, the power supply control apparatus 10 can update an arrival flag of the user in the reservation list in FIG. to an arrived state.

Subsequently, the power supply control apparatus 10 determines information about an inquiry destination terminal of the user, based on the user determination information (at least one of the moving body identification information and the user identification information) determined in S104 (S106). Note that, the processing order of S105 and S106 is not limited to the example illustrated in FIG. 9.

After S105 and S106, the power supply control apparatus 10 can output guide information via the guide apparatus 50 (S107, S109). Further, the power supply control apparatus 10 can output the guide information via the portable terminal 40 of the user by using the information about the inquiry destination terminal of the user being determined in S106 (S108, S110).

Note that, the power supply control apparatus 10 may perform only one of an output of the guide information via the guide apparatus 50 and an output of the guide information via the portable terminal 40 of the user, and may not perform the other. The modification example is also applicable to the other example below.

The power supply control apparatus 10 can output various pieces of the guide information at various timings.

For example, the power supply control apparatus 10 may output the guide information such as “Mr./Ms. ∘∘. Your arrival at reserved area L was confirmed. Thank you for choosing our service.” at any timing. User identification information and moving body identification information may be used instead of “Mr./Ms. ∘∘” (the same applies hereinafter).

Further, when the user arrives at the area L and then needs to wait for a turn, the power supply control apparatus 10 may output the guide information such as, for example, “Mr./Ms. ∘∘. We will guide you when your turn comes, so please wait for a while.” at any timing. The guide information in this case may include information indicating an estimation of the number of waiting people and a waiting time such as, for example, “Mr./Ms. ∘∘. We will guide you after M people, so please wait for a while.” and “Mr./Ms. ∘∘. We will guide you after about N minutes, so please wait for a while.”. The power supply control apparatus 10 can generate information indicating an estimation of the number of waiting people and a waiting time, based on the reservation list illustrated in FIG. 10. For example, the power supply control apparatus 10 may compute a value acquired by multiplying the number of waiting people by a predetermined time as an estimation of a waiting time, or may use the other means.

In addition, the power supply control apparatus 10 may output the guide information such as, for example, “Mr./Ms. ∘∘. Please move toward available power supply apparatus 20.” and “Mr./Ms. ∘∘. Please move toward A charging parking space.” at a timing at which the user can use the power supply apparatus 20.

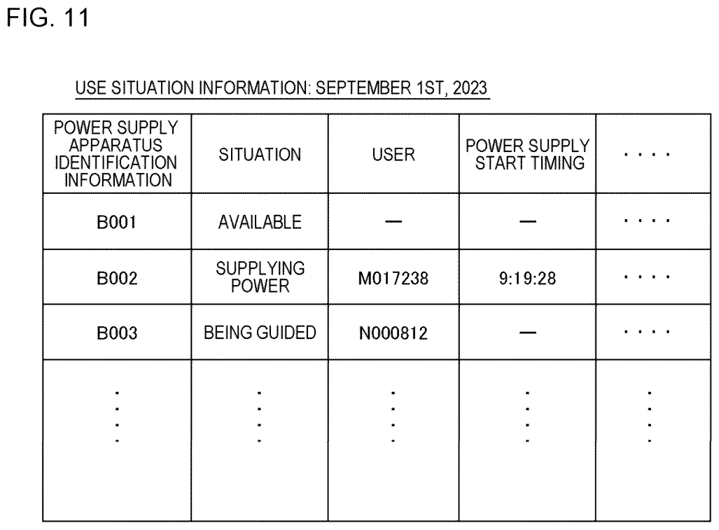

The power supply control apparatus 10 manages a use situation of each power supply apparatus 20 by using use situation information as illustrated in FIG. 11, for example. The power supply control apparatus 10 determines a timing at which the user can use the power supply apparatus 20 by using the use situation information and the reservation list. The illustrated use situation information includes power supply apparatus identification information, a situation, a user, and a power supply start timing.

The “power supply apparatus identification information” is information that identifies the plurality of power supply apparatuses 20 installed in the same area L from each other.

The “situation” indicates a situation of each power supply apparatus 20. There are various ways of classifying situations, and situations can be classified into, for example, “supplying power”, “being guided”, “available”, and the like.

“Supplying power” is a situation where a power supply is being provided to an electric moving body. In a case of the situation, moving body identification information or user identification information about a user who is using the power supply apparatus 20 is entered in a column of “user”. Then, a timing (time) at which a power supply from the power supply apparatus 20 starts is entered in a column of “power supply start timing”.

“Being guided” is a situation (situation where an output of guide information that guides the power supply apparatus 20 has been completed) where a power supply to an electric moving body has not yet been provided or a guide to the power supply apparatus 20 for a certain user has been completed. In a case of the situation, moving body identification information or user identification information about a user who is guided to the power supply apparatus 20 is entered in the column of “user”. Then, the column of “power supply start timing” is blank.

“Available” is a situation that does not apply to “supplying power” and “being guided” and is usable. In a case of the situation, the columns of “user” and “power supply start timing” are blank.

The power supply control apparatus 10 can update the use situation information described above, based on the information indicating a situation of the power supply apparatus 20 being acquired from the power supply apparatus and the management apparatus 60. Further, the power supply control apparatus 10 can update the use situation information described above, based on processing (such as an output of guide information and acceptance of an instruction to start a power supply) performed by the power supply control apparatus 10.

For example, the power supply control apparatus 10 can change a situation of the power supply apparatus 20 from “available” to “being guided” in response to an output of guide information that guides a certain user to a certain power supply apparatus 20.

Further, the power supply control apparatus 10 can change a situation of the power supply apparatus 20 from “being guided” to “supplying power” in response to reception of, from the management apparatus 60, information indicating that a power supply from the power supply apparatus 20 has started. In this case, when a power supply to an electric moving body brought into a state where a power supply from the power supply apparatus 20 can be achieved starts, the power supply apparatus 20 transmits the information indicating the start to the management apparatus 60. Then, the management apparatus 60 further transmits the information indicating the start to the power supply control apparatus 10.

In addition, the power supply control apparatus 10 may change a situation of the power supply apparatus 20 from “being guided” to “supplying power” in response to transmission of, from the power supply control apparatus to the management apparatus 60, control information that starts a power supply from the power supply apparatus 20.

Further, the power supply control apparatus 10 can change a situation of the power supply apparatus 20 from “supplying power” to “available” in response to reception of, from the management apparatus 60, information indicating that a power supply from the power supply apparatus 20 has ended. In this case, when a power supply to an electric moving body brought into a state where a power supply from the power supply apparatus 20 can be achieved ends, the power supply apparatus 20 transmits the information indicating the end to the management apparatus 60. Then, the management apparatus 60 further transmits the information indicating the end to the power supply control apparatus 10.

In addition, the power supply control apparatus 10 may change a situation of the power supply apparatus 20 from “supplying power” to “available” in response to reception of the information indicating an end of the power supply described above and detection that an electric moving body has left the charging parking space N of the power supply apparatus 20. A fact that the electric moving body has left the charging parking space N of the power supply apparatus 20 can be detected by, for example, an analysis of an image generated by the information acquisition apparatus 31.

When the power supply apparatus 20 in a situation of “available” is present, the power supply control apparatus 10 outputs guide information that guides a new user to the power supply apparatus 20.

For example, the power supply control apparatus 10 refers to the reservation list (FIG. 10), and determines a first user in a reservation order at that point in time. Then, the power supply control apparatus 10 outputs guide information that guides the determined user to the available power supply apparatus 20.

In addition, the power supply control apparatus 10 may refer to the reservation list (FIG. 10), and determine a first user in a reservation order among users who have arrived at the area L at that point in time. Then, the power supply control apparatus 10 may output guide information that guides the determined user to the available power supply apparatus 20.

The power supply control apparatus 10 can delete the user from the reservation list at any timing after the power supply control apparatus 10 outputs the guide information that guides the user to the available power supply apparatus 20.

The user moves and parks his/her electric moving body in the charging parking space N of the predetermined power supply apparatus 20 described above, based on the guide information that guides the power supply apparatus 20. Then, the electric moving body of the user and/or the user is captured in an image generated by the information acquisition apparatus 31 installed in the vicinity of the power supply apparatus 20. Then, the information acquisition apparatus 31 transmits the image (image in which the electric moving body of the user and/or the user is captured) to the power supply control apparatus 10 (S111 in FIG. 9). The power supply control apparatus 10 performs authentication processing, based on the image (S112).

In S112, the power supply control apparatus 10 performs processing similar to that in S104, and determines at least one of user identification information and moving body identification information. Then, the power supply control apparatus 10 confirms whether the determined user is a user guided to the power supply control apparatus 10. It is assumed herein that the determined user is a user guided to the power supply control apparatus 10 and the authentication succeeds. In other words, processing in and after S113 illustrated in FIG. 9 is processing performed when the authentication in S112 succeeds.

Note that, when the determined user is not a user guided to the power supply control apparatus 10, that is, when the authentication in S112 fails, the power supply control apparatus 10 can perform error processing. For example, the power supply control apparatus 10 may cause the power supply apparatus 20 or the guide apparatus 50 to output information such as “Other customer in reservation order is using the power supply apparatus 20 from now on. We are sorry. Please move moving body to other place.”. Further, when information about an inquiry destination terminal of a user being a target of the error processing is determined based on the image in S111, the information as described above may be transmitted to the portable terminal 40 of the user. Further, as the error processing, the power supply control apparatus 10 may control the power supply apparatus 20 in such a way that the power supply apparatus 20 does not supply power to the electric moving body. In other words, the power supply control apparatus 10 may transmit, to the management apparatus 60, information that prohibits a power supply from the power supply apparatus 20. Then, the management apparatus 60 may transmit, to the power supply apparatus 20, a command that prohibits the power supply, based on the information.

The user who has parked his/her electric moving body in the charging parking space N performs work for electrically connecting the power supply apparatus 20 and his/her electric moving body. When the power supply apparatus 20 detects the connection (S113), the power supply apparatus 20 notifies the management apparatus 60 of the detection (S114). Then, the management apparatus 60 further notifies the power supply control apparatus 10 of the detection (S115).

The power supply control apparatus 10 transmits, by using the information about the inquiry destination terminal of the user being determined in S106, inquiry information about use of the power supply apparatus 20 to the portable terminal 40 at any timing after S112 and S115 (S116). The inquiry information includes, for example, a UI screen including a UI part that accepts an instruction to start a power supply, or information (such as a URL) for accessing the UI screen.

The portable terminal 40 displays the UI screen on a display, and accepts an operation via the UI screen (S117). For example, the user inputs an instruction to start a power supply via the UI screen. Then, the portable terminal 40 transmits the instruction to the power supply control apparatus 10 (S118). Then, the power supply control apparatus 10 transmits, to the management apparatus 60, the instruction to start the power supply from the power supply apparatus 20 (S119). The management apparatus 60 transmits, to the power supply apparatus 20, the instruction to start the power supply according to the instruction (S120). The power supply apparatus 20 starts the power supply to the connected electric moving body according to the instruction (S121).

Subsequent processing such as, for example, a stop of a power supply and settlement processing can be achieved by using every widely known technique.

Herein, a modification example of the example 1 will be described. The modification example is also applicable to the other example.

The power supply system may not perform S113 to S115. In this case, the power supply control apparatus 10 transmits, by using the information about the inquiry destination terminal of the user being determined in S106, inquiry information about use of the power supply apparatus 20 to the portable terminal at any timing after S112 (S116). The other processing is similar to that described above.

Further, when the power supply apparatus 20 wirelessly supplies power, the power supply apparatus 20 may detect presence of an electric moving body that a wireless power supply can be achieved instead of detecting a connection in S113.

Further, a user to which guide information such as “Mr./Ms. ∘∘. Your arrival at reserved area L was confirmed. Thank you for choosing our service.” is not output regardless of a fact that the user has arrived at the reserved area L may be able to perform arrival procedure by an optional operation. For example, the user may be able to perform predetermined arrival procedure by reading a code (such as a one-dimensional code and a two-dimensional code) installed in the area L with the portable terminal 40, and accessing the power supply control apparatus 10. The code can include, for example, information that identifies the area L, information for accessing a UI screen for performing the arrival procedure, and the like. In response to completion of the arrival procedure, the power supply control apparatus 10 can set an arrival flag (see FIG. 10) of the user to an arrived state.

Further, a reservation may be effective only in a predetermined period of time since a reservation timing. The power supply control apparatus 10 may cancel a reservation by a user who has not arrived at the reserved area L even after a lapse of a predetermined period of time since a reservation timing. In this case, an effective period of time of the reservation may be able to be extended in response to procedure by the user. For example, the user who has made a reservation but may be late for arrival at the area L due to an unexpected incident such as a traffic jam can avoid, by performing the procedure, an inconvenience that the reservation is to be canceled.

When the procedure of extending an effective period of a reservation is performed, the reservation can be effective only in a period of time since a timing at which the extension procedure is performed, for example. The power supply control apparatus 10 may cancel a reservation by a user who has not arrived at the reserved area L even after a lapse of a predetermined period of time since a timing at which the extension procedure is performed. The user may be able to perform the extension procedure for a plurality of times. Further, an upper limit number of times the extension procedure can be performed may be predetermined.

The extension procedure can be achieved by using every widely known technique. For example, a user may be able to perform the extension procedure by using the portable terminal 40. In one example, a user operates an application used in the charging service by operating the portable terminal 40, specifies his/her reservation, and also performs an input for extending an effective period of the reservation. By the operation, input information is transmitted from the portable terminal 40 to the power supply control apparatus 10.

Further, a user may be able to specify a time and make a reservation. In this case, the reservation may be effective only in a predetermined period of time since the specified time. The power supply control apparatus 10 may cancel a reservation by a user who has not arrived at the reserved area L even after a lapse of a predetermined period of time since a specified time.

Further, when an electric moving body of a first user cannot be detected in the charging parking space N of the power supply apparatus 20 even after a lapse of a predetermined period of time since the first user is guided to the power supply apparatus 20, the power supply control apparatus 10 may guide another user to the power supply apparatus 20. In this case, the power supply control apparatus 10 can output guide information indicating the fact via the guide apparatus 50 or the portable terminal 40 of the first user. A content of the guide information is, for example, “Your electric moving body cannot be detected in A charging parking space even after lapse of predetermined period of time since you are guided to power supply apparatus 20 in A charging parking space, so other customer will be guided to power supply apparatus 20.”. In this case, the power supply control apparatus 10 may delete the first user from a reservation list, or may leave the first user in an original order in the reservation list.

Further, the power supply system may not include the information acquisition apparatus 30. In this case, the power supply control apparatus 10 acquires position information from the portable terminal 40 of each user. The power supply control apparatus 10 detects that each user arrives at the area L by using the position information about the portable terminal 40. Then, in response to the detection, the power supply control apparatus 10 sets an arrival flag of the user in the reservation list (see FIG. 10) to an arrived state. The power supply control apparatus 10 can acquire the position information about the portable terminal 40 from the portable terminal 40.

### Example 2 (Flow of Processing When User who Has Completed User Registration but Has no Reservation Arrives)

One example of a flow of processing when a user who has completed user registration but has no reservation arrives will be described by using the sequence diagram in FIG. 9.

In this case, the user goes to any area L without performing the processing in S101 and S102. Since the user has completed the user registration, the authentication in S104 performed after the user has arrived at the area L succeeds. However, in S105, the power supply control apparatus 10 recognizes that the user determined in S104 does not have a reservation.

After S105, when there is no usable power supply apparatus 20 (for example: the power supply apparatus 20 whose situation is “available”) at that point in time, the power supply control apparatus 10 adds the user to a last reservation order in the reservation list (see FIG. 10). Note that, the power supply control apparatus 10 can set an arrival flag of the user to an arrived state. Subsequently, the processing in and after S106 is performed. The processing in and after S106 is similar to that in the example 1.

On the other hand, after S105, when there is a usable power supply apparatus 20 (for example: the power supply apparatus 20 whose situation is “available”) at that point in time, the power supply control apparatus 10 performs S106, and then outputs guide information that guides the user to the available power supply apparatus 20 in S107 to S110. Subsequently, the processing in and after S111 is performed. The processing in and after S111 is similar to that in the example 1.

### “Example 3 (Flow of Processing When Biometric Authentication is Used for User Authentication and Acceptance of Operation Using Portable Terminal 40 is Omitted)”

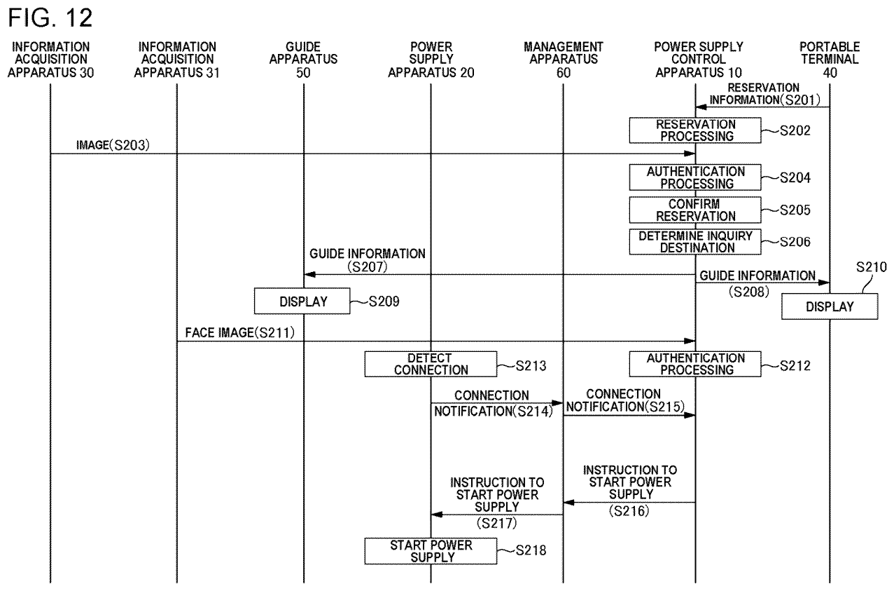

A modification example of the examples 1 and 2 will be described by using a sequence diagram in FIG. 12. In an example 3, biometric authentication using biometric information about a user is performed in authentication processing performed in the area L. Then, in the example 3, control of the power supply apparatus 20 via the portable terminal 40 is omitted. In other words, in the example 3, the biometric authentication is performed, and thus a power supply to an electric moving body starts without an operation of the portable terminal 40.

S201 to S215 are similar to those in the examples 1 and 2. However, in the example 3, the power supply control apparatus 10 performs the biometric authentication using biometric information about a user in at least one of the authentication processing in S204 and S212. The example in FIG. 12 indicates that a face image of the user is transmitted from the information acquisition apparatus 31 to the power supply control apparatus 10 in S211. Then, in the example in FIG. 12, the authentication processing is performed based on the face image in S212.

After S212 and S215, the power supply control apparatus 10 transmits, to the management apparatus 60, an instruction to start a power supply from the predetermined power supply apparatus 20 (S216). The management apparatus 60 transmits, to the power supply apparatus 20, the instruction to start the power supply according to the instruction (S217). The power supply apparatus 20 starts the power supply to the connected electric moving body according to the instruction (S218).

As clear from a comparison with FIG. 9, the example 3 does not include S116 to S118 in the examples 1 and 2.

### Example 4 (Flow of Processing When User who Has not Completed User Registration Arrives at Area L)

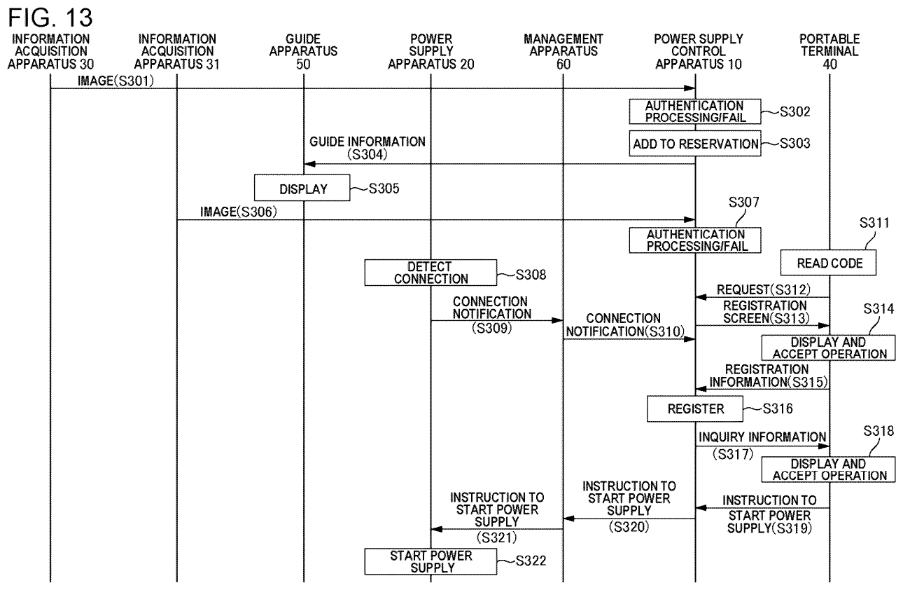

One example of a flow of processing when a user who has not completed user registration arrives at the area L will be described by using a sequence diagram in FIG. 13.

When a user who has not completed the user registration arrives at the area L, an electric moving body of the user and/or the user is captured in an image generated by the information acquisition apparatus 30 installed in the vicinity of the entrance of the area L. Then, the information acquisition apparatus 30 transmits the image (image in which the electric moving body of the user and/or the user is captured) to the power supply control apparatus 10 (S301).

The power supply control apparatus 10 performs authentication processing, based on the image (S302). As described above, the user has not completed the user registration. Thus, the authentication processing fails. Subsequently, the power supply control apparatus 10 adds the user to a last reservation order (S303). In this way, the power supply control apparatus 10 can accept a reservation by the user who arrives at the area L before the user registration. The power supply control apparatus 10 can use, as reserver information in the reservation list (see FIG. 10), moving body identification information or biometric information about a user being acquired from an image generated by the information acquisition apparatus 30. Note that, the power supply control apparatus 10 can set an arrival flag of the user to an arrived state.

Then, the power supply control apparatus 10 causes the guide apparatus 50 to output guide information (S304, S305). A content of the output guide information is similar to that in the examples 1 to 3. Note that, the user has not completed the user registration, and thus an output of the guide information via the portable terminal 40 of the user cannot be achieved at this point in time.

The power supply control apparatus 10 causes the guide apparatus 50 to output the guide information that guides the user to the available power supply apparatus 20 when a turn of the user comes. The user moves and parks his/her electric moving body in the charging parking space N of the power supply apparatus 20, based on the guide information.

Then, the electric moving body of the user and/or the user is captured in an image generated by the information acquisition apparatus 31 installed in the vicinity of the power supply apparatus 20. Then, the information acquisition apparatus 31 transmits the image (image in which the electric moving body of the user and/or the user is captured) to the power supply control apparatus 10 (S306).

The power supply control apparatus 10 performs authentication processing, based on the image (S307). In other words, the power supply control apparatus 10 confirms that the user guided to the power supply apparatus 20 parks the electric moving body in the charging parking space N of the power supply apparatus 20. For such a user who has not completed the user registration, the power supply control apparatus 10 performs the authentication processing by referring to the moving body identification information or the biometric information about the user being acquired from the image generated by the information acquisition apparatus 30 and registered in the registration list. In other words, the power supply control apparatus 10 verifies the moving body identification information or the biometric information about the user being acquired from the image generated by the information acquisition apparatus 30 with the moving body identification information or the biometric information about the user being acquired from the image generated by the information acquisition apparatus 31. In the authentication processing, the power supply control apparatus 10 can confirm that the user guided to the power supply apparatus 20 parks the electric moving body in the charging parking space N of the power supply apparatus 20.

Subsequently, the portable terminal 40 reads a code (such as a one-dimensional code and a two-dimensional code) installed in the vicinity of the power supply apparatus 20 in response to a user operation (S311), and requests a registration screen from the power supply control apparatus 10 (S312). For example, a guide such as “Only customer who has completed user registration can use charging service. If you have not completed user registration yet, please read the code and perform user registration.” may be displayed in the vicinity of the power supply apparatus 20. The user reads the code according to the guide.

When the portable terminal 40 acquires the registration screen from the power supply control apparatus 10 (S313), the portable terminal 40 displays the registration screen and accepts an operation (S314). The user performs an operation of inputting and registering various pieces of registration information as illustrated in FIG. 7 on the registration screen. Then, the portable terminal transmits the input registration information to the power supply control apparatus 10 (S315). The power supply control apparatus 10 performs the user registration of the user, based on the acquired registration information (S316).

An input of various pieces of the information as illustrated in FIG. 7 takes time and effort, and some users find the input troublesome. Thus, the power supply control apparatus 10 may fill information in a column of moving body identification information in the registration screen provided to a user with moving body identification information acquired from an image generated by the information acquisition apparatus 30 or the information acquisition apparatus 31.

Further, the power supply control apparatus 10 may acquire at least one of user information, biometric information, and a payment method from a server that provides another service. Then, the power supply control apparatus 10 may fill information in a column thereof in the registration screen provided to a user with the acquired value. In this way, the power supply control apparatus may cooperate with a server that provides another service.

As the another service, a service for saving up points, a net shopping service, a service being able to acquire profitable information such as a coupon, and the like are exemplified, which are not limited thereto. A user registers various pieces of information needed for user registration of a charging service in user registration of the services. Then, the user operates the power supply apparatus 20, inputs information that identifies the user and a password in the another service, and also performs an operation of performing the user registration of the charging service by using the information registered in the another service. In response to the operation, the power supply control apparatus 10 transmits a request for the information that identifies the user, the password, and various pieces of the information in the another service to a server that provides the another service. Then, the power supply control apparatus 10 can acquire at least one of user information, biometric information, and a payment method from the server that provides the another service.

Further, installation of an application used in the charging service may be guided on the registration screen described above. The user installs the application into the portable terminal 40 according to the guide.

The user who has parked his/her electric moving body in the charging parking space N performs work for electrically connecting the power supply apparatus 20 and his/her electric moving body. When the power supply apparatus 20 detects the connection (S308), the power supply apparatus 20 notifies the management apparatus 60 of the detection (S309). Then, the management apparatus 60 further notifies the power supply control apparatus 10 of the detection (S310). The processing order of the connection work and the user registration work described above is not particularly limited, and either of them may be performed first. Further, both of them may be performed simultaneously.

The power supply control apparatus 10 transmits, by using the information about an inquiry destination terminal of the user being registered in S316, inquiry information about use of the power supply apparatus 20 to the portable terminal 40 at any timing after S310 and S316 (S317). The inquiry information includes, for example, a UI screen including a UI part that accepts an instruction to start a power supply, or information (such as a URL) for accessing the UI screen. Subsequent processing is similar to that in the examples 1 to 3.

Herein, a modification example of the example 4 will be described. The processing described above is the example in which there is no usable power supply apparatus 20 at a point in time at which a user who has not completed user registration arrives at the area L. In such a case, the user is registered in the reservation list as described above.

On the other hand, when there is a usable power supply apparatus 20 at a point in time at which a user who has not completed user registration arrives at the area L, the power supply control apparatus 10 does not register the user in the reservation list (S303 is not performed) after S302, and can output guide information that guides the user to the available power supply apparatus 20 (S304). Subsequent processing is similar to the processing described above.

### Example 5 (Flow of Processing When Power Supply Apparatus 20 Used by User cannot be Determined by Image Analysis)

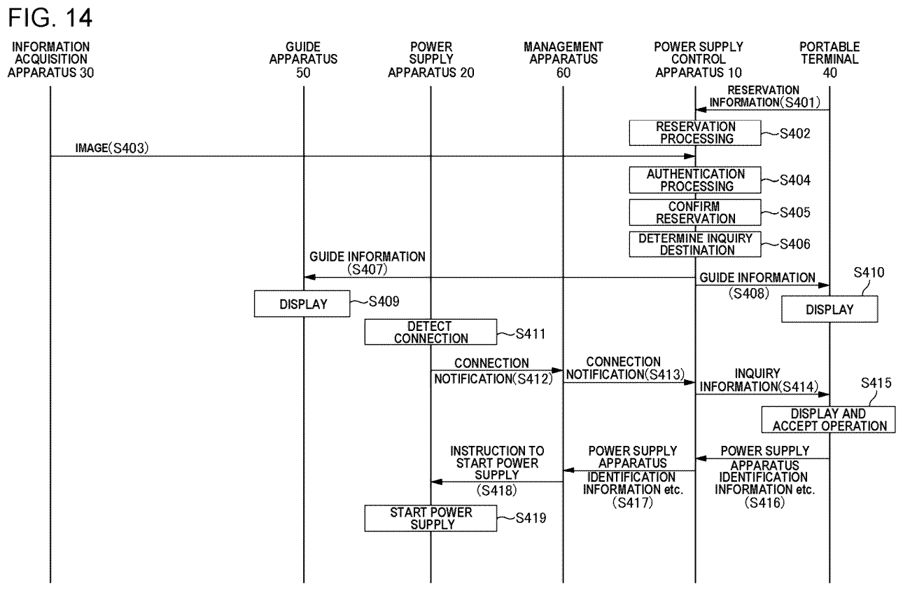

One example of a flow of processing when the power supply apparatus used by a user cannot be determined by an image analysis will be described by using a sequence diagram in FIG. 14.

As illustrated in FIG. 14, in an example 5, the power supply system does not include the information acquisition apparatus 31. Further, the power supply system does not include a camera that captures the entire region of the area L. Thus, the power supply control apparatus 10 cannot determine the power supply apparatus 20 used by a user by an image analysis. One of the flow of the processing in such a case will be described.

Processing in S401 to S410 are similar to those in the examples 1 to 4.

Subsequently, a user moves and parks his/her electric moving body in the charging parking space N of the predetermined power supply apparatus 20 described above, based on the guide information that guides the power supply apparatus 20. The user who has parked his/her electric moving body in the charging parking space N performs work for electrically connecting the power supply apparatus 20 and his/her electric moving body. When the power supply apparatus 20 detects the connection (S411), the power supply apparatus 20 notifies the management apparatus 60 of the detection (S412). Then, the management apparatus 60 further notifies the power supply control apparatus 10 of the detection (S413).

The power supply control apparatus 10 transmits inquiry information about use of the power supply apparatus 20 to the portable terminal 40 at any timing after the guide information that guides the user to the predetermined power supply apparatus 20 or after S413 (S414). The inquiry information includes, for example, a UI screen including a UI part that accepts an instruction to start a power supply, or information (such as a URL) for accessing the UI screen. The UI screen further includes a UI part that accepts an instruction to specify the power supply apparatus 20 to be used.

The portable terminal 40 displays the UI screen on a display, and accepts an operation via the UI screen (S415). For example, the user performs an input for specifying the power supply apparatus 20 to be used, and also inputs an instruction to start a power supply. Then, the portable terminal 40 transmits, to the power supply control apparatus 10, information that identifies the specified power supply apparatus 20 and information including the instruction to start the power supply (S416).

The power supply control apparatus 10 transmits, to the management apparatus 60, the instruction to start the power supply from the power supply apparatus 20 identified by the received information (S417). The management apparatus 60 transmits, to the power supply apparatus 20, the instruction to start the power supply according to the instruction (S418). The power supply apparatus 20 starts the power supply to the connected electric moving body according to the instruction (S419). Subsequent processing such as, for example, a stop of a power supply and settlement processing can be achieved by using every widely known technique.

Note that, the power supply control apparatus 10 may accept an input for specifying one of the power supply apparatuses 20 whose use situation is “available” at that point in time on the UI screen displayed on the portable terminal 40 in S415. In other words, only the power supply apparatus 20 whose use situation is “available” at that point in time may be displayed on the UI screen in such a way as to be able to be specified.

### Example 6 (Flow of Processing when Communication Network is Disconnected)

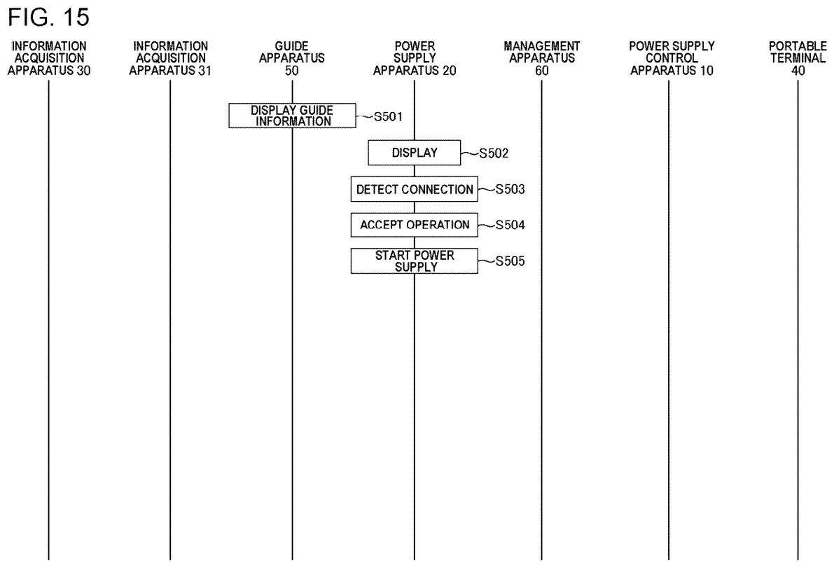

One example of a flow of processing when a communication network is disconnected will be described by using a sequence diagram in FIG. 15.

In this case, the guide apparatus 50 can always output guide information such as “Reservation management fails due to communication failure. Please be free to move toward available power supply apparatus 20.” (S501).

For example, when disconnection of a communication network occurs, a worker may always display the guide information as described above by operating the guide apparatus 50. In addition, the guide apparatus 50 may regularly perform a communication test with an external apparatus such as the power supply control apparatus 10 for confirming a communication state. Then, the guide apparatus 50 may always display the guide information as described above when disconnection of a communication network is detected as a result of the communication test.

Further, the power supply apparatus 20 can output information such as “Power supply control using portable terminal fails due to communication failure. Please perform power supply control by operating power supply apparatus 20.” via an output apparatus included in the power supply apparatus (S502).

For example, when disconnection of a communication network occurs, a worker may switch to a predetermined mode by operating the power supply apparatus 20. In response to setting of the predetermined mode, the power supply apparatus 20 can perform display of the information as described above and processing in S503 to S505. In addition, the management apparatus 60 may regularly perform a communication test with an external apparatus such as the power supply control apparatus 10 for confirming a communication state. Then, the management apparatus 60 may transmit a command for switching to the predetermined mode as described above to the power supply apparatus 20 when disconnection of a communication network is detected as a result of the communication test. For example, the power supply apparatus 20 and the management apparatus 60 are connected to each other on a local communication network such as a local area network (LAN), and communication can be achieved even under a situation where disconnection of the communication network occurs as described above.

The user who has parked his/her electric moving body in the charging parking space N according to the guide information in S501 performs work for electrically connecting the power supply apparatus 20 and his/her electric moving body. The power supply apparatus 20 detects the connection (S503). Further, the power supply apparatus 20 accepts an operation on the power supply apparatus 20, specifically, an operation of starting a power supply, an operation of specifying a power amount for a power supply or a time for a power supply, an operation of selecting a payment method, and the like (S504). In a case of a state where disconnection of a communication network is detected, only cash may be selectable as a payment method.

Subsequently, the power supply apparatus 20 starts the power supply to the connected electric moving body (S505). Subsequent processing such as, for example, a stop of a power supply and settlement processing can be achieved by using every widely known technique. For example, the power supply apparatus 20 may register, in the power supply apparatus 20, information about a provided power supply (such as a date and time of a power supply, a power amount for a power supply, and a settlement amount of money). The information may be transmitted from the power supply apparatus 20 to the power supply control apparatus 10 via the management apparatus 60 at any timing after the communication network is recovered.

Herein, a modification example of the example 6 will be described. A user who has completed user registration may be able to use a deferred payment service. Then, the deferred payment service can be used as a payment method in a case of a state where disconnection of a communication network is detected.

The deferred payment service is, for example, a service for collectively settling a use fee of a charging service in a predetermined period (for example: one month) at any subsequent timing. In this case, the power supply apparatus or the management apparatus 60 performs user authentication by any means such as biometric authentication and password authentication. Data referred in the user authentication are stored in advance in a local storage apparatus. The power supply apparatus 20 or the management apparatus 60 performs authentication processing by using the data stored in the storage apparatus. For example, the power supply apparatus 20 or the management apparatus 60 is connected to the storage apparatus on a local communication network such as a LAN.

When the user authentication succeeds, the power supply apparatus 20 accepts use of the deferred payment service. Then, the power supply apparatus registers, in the power supply apparatus 20 or the management apparatus 60, information indicating use of the deferred payment service and the above-described information about a provided power supply in association with user identification information. The information may be transmitted to the power supply control apparatus 10 at any timing after the communication network is recovered.

### Advantageous Effect

The power supply control apparatus 10 according to the present example embodiment can achieve an advantageous effect similar to that of the power supply control apparatus 10 in the first example embodiment.

Further, the power supply control apparatus 10 in the present example embodiment can appropriately manage a reservation for a charging service as described as the examples. As a result, a user can reduce a waiting time after arrival at the area L.

Further, according to the power supply control apparatus 10 in the present example embodiment, a user who has arrived at the area L without making a reservation and a user who has arrived at the area L without performing user registration can also use a charging service as described as the examples. In this way, the power supply control apparatus 10 in the present example embodiment can provide a charging service to not only a user who has made a reservation and has arrived at the area L but also a user who has arrived at the area L without making a reservation and a user who has arrived at the area L without performing user registration.

Further, according to the power supply control apparatus 10 in the present example embodiment, a user can also use a charging service even when a communication network is disconnected as described as the examples. In this way, the power supply control apparatus 10 in the present example embodiment can also provide a service to a user in an unexpected situation.

### Modification Example

Modification examples that are applicable to the first and second example embodiments will be described.

### Modification Example 1

A mechanism for controlling an entry into the charging parking space N may be provided in each charging parking space N of each power supply apparatus 20. The mechanism is, for example, a flapper gate, and the like. Then, when the authentication in S112 in FIG. 9, S212 in FIG. 12, and S307 in FIG. 13 succeeds, the power supply control apparatus 10 may control the mechanism, and set a state where an entry into the charging parking space N is allowed.

The modification example can suppress an inconvenience that a user whose turn has not yet come parks the charging parking space N by mistake and uses the power supply apparatus 20.

### Modification Example 2

When a user who has parked in the charging parking space N does not move an electric moving body from the space even after charging ends, the power supply control apparatus 10 may claim, from the user, an additional fee according to an elapsed time from a charging completion point in time.

The power supply control apparatus 10 computes the additional fee according to a time from the “charging completion point in time” until a “timing at which the electric moving body is moved from the charging parking space N”. Then, the power supply control apparatus 10 registers the computed additional fee in association with the user. The power supply control apparatus 10 can claim the additional fee by any means.

For example, when a user uses the deferred payment service described in the example 6, the additional fee can be added to a claim for a predetermined period.

Further, the power supply control apparatus 10 can add the additional fee described above to a fee of a charging service use at that time, and claim the fee, from a user, at a time of a next charging service use.

### Modification Example 3

In the second example embodiment, the example in which an application used in a charging service is installed into the portable terminal 40 is described as a means for achieving the configuration for accepting various operations of the charging service by using the portable terminal 40 of a user. As a modification example, the power supply control apparatus 10 may be configured to send a link by a short message service (SMS), an e-mail, a short message, and the like, and accept various operations of a charging service via a control application of a link destination.

### Modification Example 4

The acquisition unit 11 may analyze an image generated by the information acquisition apparatus 30 or the information acquisition apparatus 31 and determine moving body identification information about a moving body captured in the image, and then analyze an image generated by the information acquisition apparatus 30 or the information acquisition apparatus 31 and determine user identification information about a user captured in the image.

For example, the acquisition unit 11 may analyze an image generated by the information acquisition apparatus 30, and determine moving body identification information about a moving body captured in the image. Then, the acquisition unit 11 may analyze an image generated by the information acquisition apparatus 31, and determine user identification information about a user captured in the image.

For example, when a plurality of users use one electric moving body, there is a possibility that the plurality of users are registered in the power supply control apparatus 10 in association with one electric moving body. In other words, one piece of moving body identification information may be registered in association with a plurality of pieces of user identification information in information registered in user registration as illustrated in FIG. 7. In such a case, by determining user identification information in addition to moving body identification information, a target (user) of a fee claim for use of a charging service can be accurately determined.

Note that, the acquisition unit 11 can determine user identification information about a user captured in an image by biometric authentication using biometric information. In the biometric authentication, the acquisition unit 11 verifies biometric information about a user being extracted from an image with biometric information (hereinafter, reference information) about each of a plurality of preregistered users. The acquisition unit 11 may narrow down the reference information to be used in the biometric authentication by using a determination result of moving body identification information. Specifically, the acquisition unit 11 can determine user identification information registered in association with determined moving body identification information, and use, in the biometric authentication, reference information registered in association with the determined user identification information. The biometric authentication can be made faster by narrowing down the reference information referred in the biometric authentication in such a manner. Further, accuracy of the biometric authentication can improve by narrowing down the reference information with high accuracy as in the example.

### Modification Example 5

At least one of the information acquisition apparatus 30 and the information acquisition apparatus 31 may be configured to perform short-range wireless communication with a storage apparatus carried by a user, and acquire user determination information stored in the storage apparatus. The storage apparatus carried by a user is the portable terminal 40, an integrated circuit (IC) card, an IC tag, and the like, which are not limited thereto.

Further, at least one of the information acquisition apparatus 30 and the information acquisition apparatus 31 may be configured to read a code displayed on the portable terminal 40, and acquire user determination information. Note that, a user may use a code being printed out instead of a code being displayed on the portable terminal 40.

Although the present disclosure has been described above with reference to the example embodiments, the present disclosure is not limited to the above-described example embodiments. Various modifications that can be understood by those skilled in the art can be made to the configuration and the details of the present disclosure within the scope of the present disclosure. Then, each of the example embodiments can be appropriately combined with the other example embodiment.

Further, the plurality of steps (processing) are described in order in the plurality of flowcharts and sequence diagrams used in the above-described description. However, an execution order of the steps performed in each of the example embodiments is not limited to the described order. In each of the example embodiments, an order of illustrated steps may be changed within an extent that there is no harm in context.

A part or the whole of the above-mentioned example embodiments may also be described in supplementary notes below, which is not limited thereto.
1. A power supply control apparatus including:
   an acquisition unit that acquires, by using an information acquisition apparatus, user determination information that determines a user;
   an inquiry destination determination unit that determines information about an inquiry destination terminal of the user, based on the user determination information;
   a transmission/reception unit that transmits inquiry information about use of a power supply apparatus to the inquiry destination terminal; and
   a control unit that controls a power supply from the power supply apparatus in response to a response to the inquiry information.
2. The power supply control apparatus according to supplementary note 1, wherein
   the inquiry information includes a UI screen including a UI part that accepts an instruction to start a power supply, and
   the control unit starts a power supply from the power supply apparatus in response to an operation on the UI part.
3. The power supply control apparatus according to supplementary note 2, wherein
   the inquiry information further includes a UI part that specifies a power amount for a power supply and a time for a power supply.
4. The power supply control apparatus according to any of supplementary notes 1 to 3, further including
   a power supply apparatus determination unit that determines the power supply apparatus used by the user, based on the user determination information, wherein
   the transmission/reception unit transmits the inquiry information to the inquiry destination terminal at a predetermined timing after information about the inquiry destination terminal of the user is determined and the power supply apparatus used by the user is determined.
5. The power supply control apparatus according to any of supplementary notes 1 to 4, wherein
   the inquiry destination terminal is a portable terminal possessed by the user.
6. The power supply control apparatus according to any of supplementary notes 1 to 5, wherein
   the user determination information is identification information about a moving body of the user or identification information about the user, and
   the information acquisition apparatus is a camera installed in an area where the power supply apparatus is installed.
7. The power supply control apparatus according to any of supplementary notes 1 to 6, wherein
   a plurality of the information acquisition apparatuses are installed in an area where the power supply apparatus is installed,
   one of the information acquisition apparatuses is installed at an entrance of the area, and
   another one of the information acquisition apparatuses is installed in a vicinity of the power supply apparatus.
8. The power supply control apparatus according to supplementary note 7, wherein
   the power supply apparatus and the information acquisition apparatus installed in a vicinity of the power supply apparatus are associated with each other in advance, and
   the control unit controls a power supply from the power supply apparatus associated with the information acquisition apparatus that acquires the user determination information, in response to a response to the inquiry information.
9. The power supply control apparatus according to any of supplementary notes 1 to 8, wherein
   the inquiry destination determination unit determines information about the inquiry destination terminal of the user, based on information in which the user determination information and information about the inquiry destination terminal of the user are preregistered in association with each other.
10. The power supply control apparatus according to any of supplementary notes 1 to 9, wherein
   the user determination information is identification information about a moving body of the user and identification information about the user, and
   the acquisition unit
      determines identification information about a moving body of the user, and then determines identification information about the user by biometric authentication, and
      narrows down information referred in the biometric authentication, based on the determined identification information about the moving body of the user.
11. A power supply control method including, by one or more computers:
   acquiring, by using an information acquisition apparatus, user determination information that determines a user;
   determining information about an inquiry destination terminal of the user, based on the user determination information;
   transmitting inquiry information about use of a power supply apparatus to the inquiry destination terminal; and
   controlling a power supply from the power supply apparatus in response to a response to the inquiry information.
12. A program causing a computer to function as:
   an acquisition unit that acquires, by using an information acquisition apparatus, user determination information that determines a user;
   an inquiry destination determination unit that determines information about an inquiry destination terminal of the user, based on the user determination information;
   a transmission/reception unit that transmits inquiry information about use of a power supply apparatus to the inquiry destination terminal; and
   a control unit that controls a power supply from the power supply apparatus in response to a response to the inquiry information.
13. A power supply system including:
   the power supply control apparatus according to any of supplementary notes 1 to 10; and
   a power supply apparatus in which a power supply is controlled by the power supply control apparatus.

A part or the whole of supplementary notes 2 to 10 subordinate to the power supply control apparatus according to supplementary note 1 described above may also be subordinate to the power supply control method according to supplementary note 11 and the program according to supplementary note 12 in a similar subordinate relationship between supplementary note 1 and supplementary notes 2 to 10. Furthermore, a part or the whole of the configuration described as supplementary notes can be achieved in various pieces of hardware and software, various recording units for recording software, or a system without departing from each of the example embodiments described above.
10 Power supply control apparatus
11 Acquisition unit
12 Inquiry destination determination unit
13 Transmission/reception unit
14 Control unit
15 Power supply apparatus determination unit
20 Power supply apparatus
30 Information acquisition apparatus
31 Information acquisition apparatus
40 Portable terminal
50 Guide apparatus
60 Management apparatus
1A Processor
2A Memory
3A Input/output I/F
4A Peripheral circuit
5A Bus

1. A power supply control apparatus comprising:
at least one memory configured to store one or more instructions; and
at least one processor configured to execute the one or more instructions to:
acquire, by using an information acquisition apparatus, user determination information that determines a user;
determine information about an inquiry destination terminal of the user, based on the user determination information;
transmit inquiry information about use of a power supply apparatus to the inquiry destination terminal; and
control a power supply from the power supply apparatus in response to a response to the inquiry information.

2. The power supply control apparatus according to claim 1, wherein
the inquiry information includes a user interface (UI) screen including a UI part that accepts an instruction to start a power supply, and
the at least one processor is further configured to execute the one or more instructions to start a power supply from the power supply apparatus in response to an operation on the UI part.

3. The power supply control apparatus according to claim 2, wherein
the inquiry information further includes a UI part that specifies a power amount for a power supply and a time for a power supply.

4. The power supply control apparatus according to claim 1, wherein
the at least one processor is further configured to execute the one or more instructions to determine the power supply apparatus used by the user, based on the user determination information, and
transmit the inquiry information to the inquiry destination terminal at a predetermined timing after information about the inquiry destination terminal of the user is determined and the power supply apparatus used by the user is determined.

5. The power supply control apparatus according to claim 1, wherein
the inquiry destination terminal is a portable terminal possessed by the user.

6. The power supply control apparatus according to claim 1, wherein
the user determination information is identification information about a moving body of the user or identification information about the user, and
the information acquisition apparatus is a camera installed in an area where the power supply apparatus is installed.

7. The power supply control apparatus according to claim 1, wherein
a plurality of the information acquisition apparatuses are installed in an area where the power supply apparatus is installed,
one of the information acquisition apparatuses is installed at an entrance of the area, and
another one of the information acquisition apparatuses is installed in a vicinity of the power supply apparatus.

8. The power supply control apparatus according to claim 7, wherein
the power supply apparatus and the information acquisition apparatus installed in a vicinity of the power supply apparatus are associated with each other in advance, and
the at least one processor is further configured to execute the one or more instructions to control a power supply from the power supply apparatus associated with the information acquisition apparatus that acquires the user determination information, in response to a response to the inquiry information.

9. The power supply control apparatus according to claim 1, wherein
the at least one processor is further configured to execute the one or more instructions to determine information about the inquiry destination terminal of the user, based on information in which the user determination information and information about the inquiry destination terminal of the user are preregistered in association with each other.

10. The power supply control apparatus according to claim 1, wherein
the user determination information is identification information about a moving body of the user and identification information about the user, and
the at least one processor is further configured to execute the one or more instructions to
determine identification information about a moving body of the user, and then determine identification information about the user by biometric authentication, and
narrow down information referred in the biometric authentication, based on the determined identification information about the moving body of the user.

11. A power supply control method comprising,
by one or more computers:
acquiring, by using an information acquisition apparatus, user determination information that determines a user;
determining information about an inquiry destination terminal of the user, based on the user determination information;
transmitting inquiry information about use of a power supply apparatus to the inquiry destination terminal; and
controlling a power supply from the power supply apparatus in response to a response to the inquiry information.

12. The power supply control method according to claim 11, wherein
the inquiry information includes a user interface (UI) screen including a UI part that accepts an instruction to start a power supply, and
the one or more computers start a power supply from the power supply apparatus in response to an operation on the UI part.

13. The power supply control method according to claim 12, wherein
the inquiry information further includes a UI part that specifies a power amount for a power supply and a time for a power supply.

14. The power supply control method according to claim 11, wherein
the one or more computers
determine the power supply apparatus used by the user, based on the user determination information, and
transmit the inquiry information to the inquiry destination terminal at a predetermined timing after information about the inquiry destination terminal of the user is determined and the power supply apparatus used by the user is determined.

15. The power supply control method according to claim 11, wherein
the inquiry destination terminal is a portable terminal possessed by the user.

16. A non-transitory storage medium storing a program causing a computer to:
acquire, by using an information acquisition apparatus, user determination information that determines a user;
determine information about an inquiry destination terminal of the user, based on the user determination information;
transmit inquiry information about use of a power supply apparatus to the inquiry destination terminal; and
control a power supply from the power supply apparatus in response to a response to the inquiry information.

17. The non-transitory storage medium according to claim 16, wherein
the inquiry information includes a user interface (UI) screen including a UI part that accepts an instruction to start a power supply, and
the one or more computers start a power supply from the power supply apparatus in response to an operation on the UI part.

18. The non-transitory storage medium according to claim 17, wherein
the inquiry information further includes a UI part that specifies a power amount for a power supply and a time for a power supply.

19. The non-transitory storage medium according to claim 16, wherein
the program causing the computer to determine the power supply apparatus used by the user, based on the user
determination information, and
transmit the inquiry information to the inquiry destination terminal at a predetermined timing after information about the inquiry destination terminal of the user is determined and the power supply apparatus used by the user is determined.

20. The non-transitory storage medium according to claim 16, wherein
the inquiry destination terminal is a portable terminal possessed by the user.
